(19) United States
(12) Patent Application Publication
(10) Pub. No.: US 2005/0102152 A1
(43) Pub. Date: May 12, 2005

(54) Commercial real estate property management system

(76) Inventor: Kevin Hodges, Foothill Ranch, CA (US)

Correspondence Address: Marlene Klein, Esq.;STETINA BRUNDA GARRED & BRUCKER, Suite 250, 75 Enterprise, Aliso Viejo, CA, 92656, US

(21) Appl. No.: 10/703,302

(22) Filed: Nov. 7, 2003

(51) Int. Cl. G06F 17/60

(52) U.S. Cl. 705/1

(57) ABSTRACT

A system and method for providing storage for and access to tenant/property information about a plurality of real estate properties are disclosed herein. The tenant/property information for each real estate property includes an identification of the responsible party for each of a plurality of specified lease items. The responsible party may be the landlord, the tenant, the landlord via impound or an association. The identification of the responsible party for a lease item for a real estate property is retrieved in response to a query as to the identification of the responsible party for the lease items for the real estate property. The identification of the responsible party for the respective lease item for the respective real estate property is returned (e.g., to a user that requested the information).

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to data management and more particularly to management of commercial real estate properties.

A leased property, such as a commercial building, like any property often requires maintenance and repairs, such as fixing or replacing a leaky roof, fixing or replacing a broken air conditioner, landscape maintenance, etc. When such maintenance or repair issues arise, the tenant occupying the property requiring the maintenance or repair typically does not look at the lease to determine who is responsible for the needed maintenance or repair. Rather, the tenant typically telephones the landlord (i.e., the owner of the building or a property management company hired by the owner of the building). The tenant most likely feels that one phone call should not inconvenience the landlord. However, commercial landlords can receive many phone calls from tenants every day. Thus, the landlord typically spends a great deal of time dealing with the above-described type of tenant phone calls.

In the past, when the landlord received a phone call from a tenant inquiring about required maintenance or repairs, the landlord would typically have to find the lease and read the lease to determine whose responsibility it was to remedy the problem described by the tenant. Responding to all of these phone calls is time consuming for the landlord or property management company. Quite often the tenant is responsible for the needed repair or maintenance. If the tenant is responsible for the needed repair or maintenance, there is typically no need for the landlord to have any involvement with the maintenance or repair issue.

Many aspects of the landlord's job have been made easier through automation. For example, U.S. Pat. No. 6,334,107B1 entitled METHOD OF MANAGING A REAL ESTATE UNIT discloses a system and method for managing a real estate system from a remote location. The online system allows a user (e.g., a property manager) to view information about various rental properties, such as descriptions of properties, status of accounts (such as rent due, security deposit information, etc.).

Some of the automated systems track status of required maintenance tasks such as, U.S. patent application Pub. No. 2003/0023610A1 entitled ONLINE REAL AND PERSONAL PROPERTY MANAGEMENT SYSTEM AND METHOD which discloses a property management system that stores information relating to the management of a particular property including maintenance tasks, such as deodorizing garbage disposals, flushing air conditioners, cleaning refrigerators, watering gardens, etc. Upon conveyance (e.g., sale) of the property, the information can be merged for use by the new property owner.

Another example of an automated system for use in property management is disclosed in U.S. patent application Pub. No. 2002/0069230A1 entitled ELECTRONIC INFORMATION MANAGEMENT SYSTEM FOR ABSTRACTING AND REPORTING DOCUMENT INFORMATION which discloses an electronic management system for storing documents in a central database and abstracting information from the stored documents. The documents may include financial and non-financial information of a lease and its supporting documents, such as rent rolls, square footage reconciliations and correspondence. Typical information abstracted, evaluated and verified includes: general lease information, such as property name, lease status, important dates, and contract/notice parties; financial information, such as, rent schedules, recurring charges, percentage rental, renewal options, improvement allowances, commissions, security deposits and late fess; non-financial legal information, such as, tenant and landlord covenants, tenant and landlord restrictions, exclusive rights, use restrictions, co-tenancy requirements, laws and ordinances, insurance requirements, default specifications, damage specifications, marketing and promotions, holdover, kick out, relocation, radius restrictions; operational information, such as, landlord and tenant maintenance, structural repairs and HVAC tracking and forecasting; and lease issues, such as inconsistencies and discrepancies found between the lease and its supporting documents, such as rent roll miscalculations, incomplete subletting/assignment information and tenant name change histories, etc.

While automated systems such as those described above help make the landlord's job easier and save the landlord time, none of these systems address the above-described problem of facilitating the process of determining who is legally responsible for a given repair or maintenance issue so that the problem can be quickly resolved. Most importantly and in all cases, no action can be taken until the lease is researched and a legal determination has been made as to who will be legally responsible for correcting certain property deficiencies. For example, when multiplying this task of lease research with 500 building deficiencies discovered during annual inspections in a large portfolio of properties, one could imagine how time consuming it would be to research each lease 500 times in order to determine which party should take action on each deficiency whether it be Tenant, Landlord, Landlord via Impound, or Association.

Thus, there is a need for a property management system that reduces the time involved with retrieving landlord/tenant responsibility information. Preferably, if the problem is one for which the tenant bears the responsibility, the tenant can automatically be informed that the problem is the tenant's responsibility without the landlord ever having to be involved.

Another property management function that consumes a large percentage of a landlord's time is notifying tenants of repairs that require the tenant's attention. For example, if the tenant is responsible for landscape maintenance and an inspection of the property reveals that landscape maintenance is required, the landlord must notify the tenant of the problem and inform the tenant that it is the tenant's responsibility to take action. Not only does this require a significant amount of the landlord's time, but tenants often fail to timely attend to the required maintenance/repair work. Thus, additional time is required to follow-up. Therefore, there is also a need for minimizing the time required for a landlord to notify tenants of items that require the tenant's attention.

### BRIEF SUMMARY OF THE INVENTION

A system and method for providing storage for and access to tenant/property information about a plurality of real estate properties are disclosed herein. The tenant/property information for each real estate property includes an identification of the responsible party for each of a plurality of specified lease items. The responsible party may be the landlord, the tenant, the landlord via impound or an association. The identification of the responsible party for a lease item for a real estate property is retrieved in response to a query as to the identification of the responsible party for the lease items for the real estate property. The identification of the responsible party for the respective lease item for the respective real estate property is returned (e.g., to a user that requested the information).

Prior to a user querying for identification, a user validation procedure is performed. The user validation procedure includes: providing a user interface for entry of user identification information; obtaining user identification information from a user; validating the user identification information; and if the user identification information is valid, determining a user type based on the user identification information. The primary user types are tenant and landlord. Additional user types may include inspectors and/or vendors.

The functions available to a user via the user interface are based on the user type that is determined based on the user's login information. Some functions are available to all user types and some functions are only available to certain user types.

A task user interface allows users to create tasks. A task defines a function that needs to be performed. The task is associated with a lease item. The responsible party for the task is determined based on the stored information that includes the responsibility information for each item for a given property/tenant.

When a task is created, the responsible party is notified of the task. The notification may be via e-mail. The landlord is notified of all tasks. For example, if the task is the tenant's responsibility, both the tenant and the landlord receive notification of the task.

The user may display all of the pending tasks for a selected property/tenant. A task may have a picture associated with the task. The user can view the associated picture, if there is an associated picture. The tasks, including associated pictures may be created by inspectors. Landlords and tenants can also create tasks. Landlords can edit tasks. Landlords can designate tasks as being complete. Tasks may be designated as recurring, e.g., require perform on an annual basis.

The user may display a copy (e.g., PDF version) of the lease. The user can also view the legal information. The legal information is the responsibility information that was extracted from the lease.

The user can display information about the building. The landlord can edit information about the building.

The user can view information about the tenant.

Vendor information may be displayed. Vendor information includes information, such as contact information for vendors that may be used for accomplishing various tasks. The vendors are assigned to each specified lease item to be notified and dispatched to perform tasks that are the responsibility of the landlord or the landlord via impound.

Data can be imported/exported from/to external programs. For example, data may be imported from or exported to a third party contact information program, a third party database program or a third party accounting program.

The above-described method may be implemented on a system for managing a plurality of real estate properties that includes: a landlord tenant responsibility data repository, at least one landlord computer, at least one tenant computer and a communication medium. The landlord tenant responsibility data repository is configured to store data about a plurality of real estate properties. The data repository includes an identification of a responsible party for each of a plurality of specified lease items for each of the real estate properties. The at least one landlord computer is configured to store the identification of the responsible party for each of the plurality of specified lease items for each of the real estate properties in the data repository and to access the stored identification of the responsible party for each of the plurality of specified lease items for each of the real estate properties from the data repository. The at least one tenant computer is configured to access the stored identification of the responsible party for each of the plurality of specified lease items for at least a respective one of the real estate properties. The communication medium facilitates the access of the stored identification of the responsible party for each of the plurality of specified lease items for at least a respective one of the real estate properties by the at least one tenant.

The at least one tenant computer may access the stored identification of the responsible party for each of the plurality of specified lease items for at least a respective one of the real estate properties over the Internet.

The system may also include at least one inspector computer configured to store inspection information for at least one of the real estate properties.

The system may also include a server.

### BRIEF DESCRIPTION OF THE DRAWINGS

These as well as other features of the present invention will become more apparent upon reference to the drawings wherein:

FIG. 1 is a hierarchical diagram showing the parties involved in a commercial real estate property management relationship;

FIG. 2A is a block diagram illustrating an exemplary system configuration for a system that stores and allows access to commercial real estate information including landlord/tenant responsibility information for a single landlord;

FIG. 2B is a block diagram illustrating an exemplary system configuration for a system that stores and allows access to commercial real estate information including landlord/tenant responsibility information for multiple landlords;

FIGS. 3A-3C illustrate an exemplary list of landlord/tenant responsibilities;

FIGS. 4-13 illustrate exemplary user interface displays for use by a user of a property management system that stores landlord/tenant responsibility information;

FIG. 14A illustrates an exemplary deficiency letter from a landlord to a tenant that is generated by a property management system, such as the one including the user interface of FIG. 4;

FIG. 14B illustrates an exemplary attachment including pictures showing deficiencies and text describing the deficiencies for inclusion with a deficiency letter such as the one shown in FIG. 13A and 14A;

FIG. 15A-15B is a flow diagram illustrating exemplary logic performed by a property management system that stores and allows access to landlord/tenant responsibility information.

### DETAILED DESCRIPTION OF THE INVENTION

A property management system is disclosed herein. The property management system disclosed herein facilitates the determination of who is responsible for a given lease item, such as repairs, maintenance or payment of bills. The system stores an identification of the party that is responsible for each of the specified lease items so that a user, such as a landlord or tenant can determine who is responsible for a given item. In exemplary embodiments, the system also allows an inspector to upload inspection information that the landlord can then send to the tenant if the tenant is responsible for any deficiencies uncovered in the inspection. Preferably, such a notification to the tenant is automatically generated.

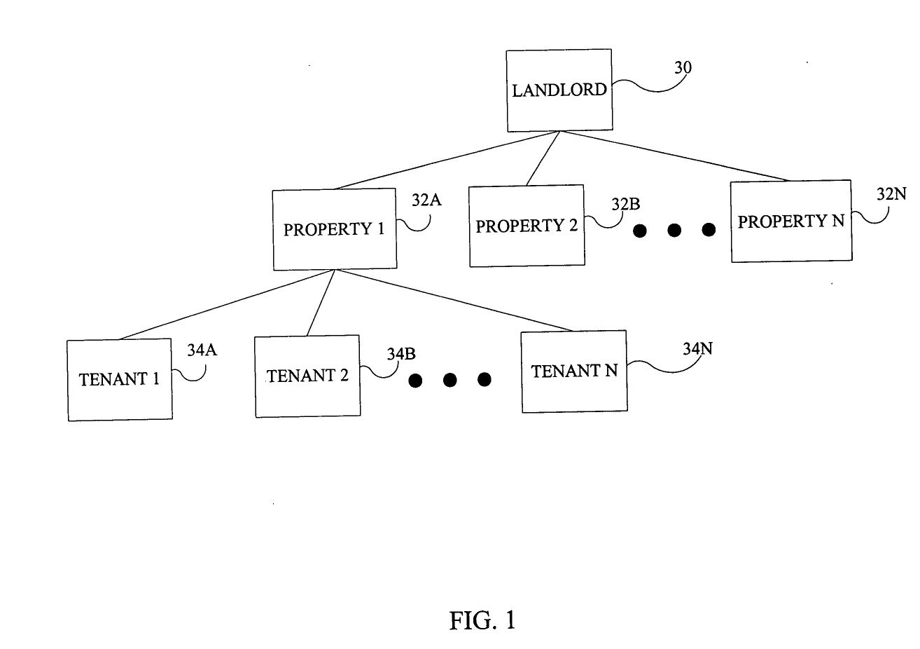

Referring now to the drawings wherein the showings are for purposes of illustrating preferred embodiments of the present invention only, and not for purposes of limiting the same, FIG. 1 is a hierarchical diagram showing the parties involved in a commercial real estate property management relationship. The exemplary embodiment shown includes real estate properties for one landlord. In exemplary embodiments, all of the data for a particular landlord resides on a computer under the landlord's control. For example, the landlord may have a personal computer (PC) which is used to store the landlord/tenant responsibility information. It will be appreciated that in other embodiments a remote server could store the commercial property information for multiple landlords. Preferably, the various landlords and their tenants can all access their particular information that is stored on the server via the Internet.

As shown in FIG. 1, the landlord 30 may have multiple properties 32A, 32B . . . 32N. Each property may have multiple tenants 34A, 34B . . . 34N. It will be appreciated that a landlord 30 may have only one property and/or a property may have only one tenant. It will also be appreciated that a particular tenant 34A, 34B . . . 34N may be leasing/renting multiple suites in a given property and/or suites in multiple properties.

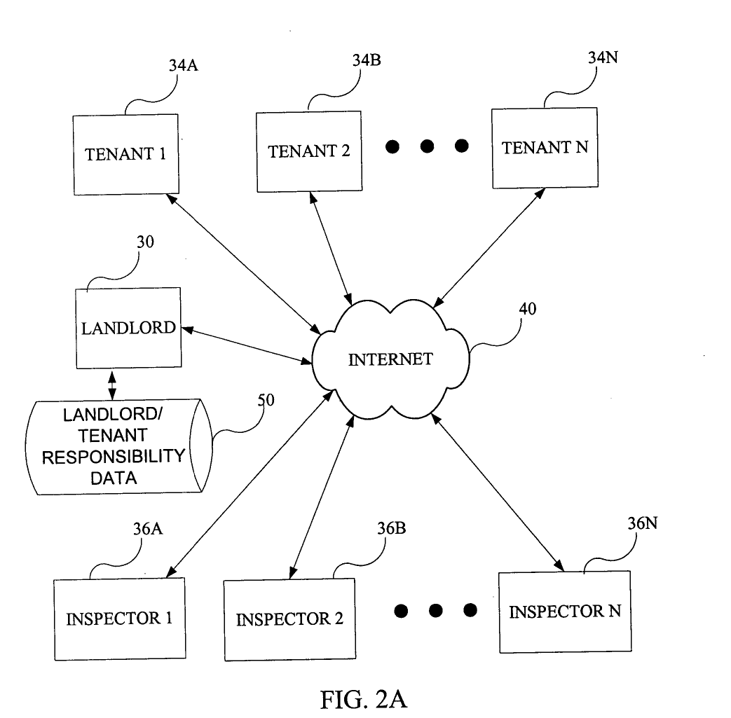

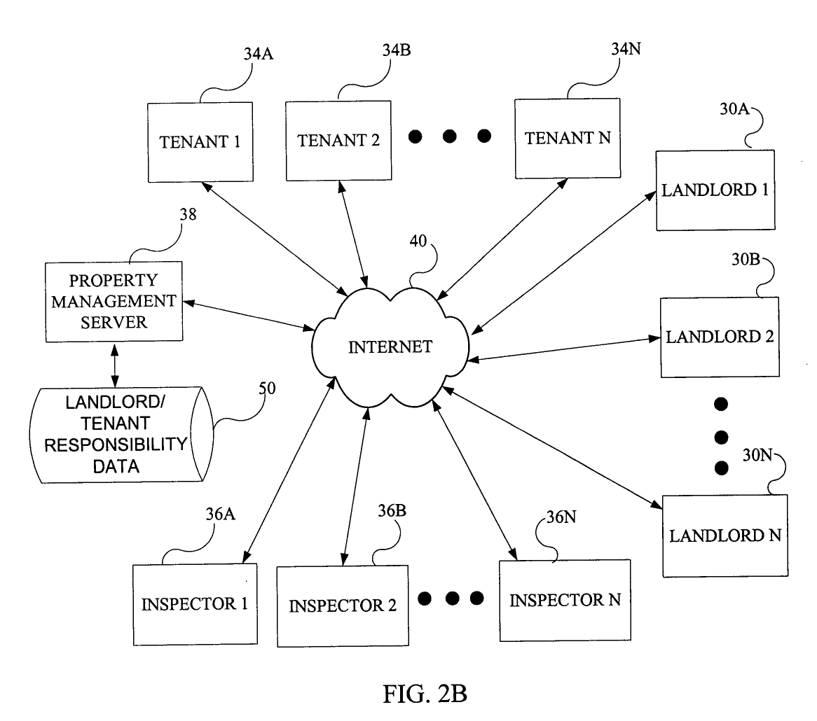

FIGS. 2A and 2B are block diagrams illustrating exemplary system configurations. In the configuration shown in FIG. 2A the landlord/tenant responsibility information 50 is stored at the landlord's site 30. The landlord/tenant responsibility data repository 50 under the landlord's control may contain information about multiple properties 32A, 32B . . . 32N. The tenants 34A, 34B . . . 34N can access information about the property or properties that they are leasing from the landlord 30 via the Internet 40. Inspectors 36A, 36B . . . 36N can store information about the properties 32A,32B . . . 32N via the Internet 40.

In the configuration shown in FIG. 2B, property management server 38 stores property management information including landlord/tenant responsibility information 50 for multiple landlords 30A, 30B . . . 30N. As in the configuration shown in FIG. 2A, the tenants 34A, 34B . . . 34N can view information pertaining to their property or properties via the Internet 40. Inspectors 36A, 36B . . . 36N can store inspection information about the properties 32A, 32B . . . 32N via the Internet 40.

The landlord/tenant responsibility data repository 50 includes tenant/property information including tenant contact information and landlord/tenant responsibility information extracted from the lease. In exemplary embodiments, the landlord/tenant responsibility information is automatically extracted from the lease. For example, the lease information may be in digital format and directly extractable, the information may be scanned and extracted based on keywords, etc. In other embodiments, the information is manually entered, i.e., a person reads the information from the lease and enters the information, including an identification of the responsible party for each of the lease items, for storage in the data repository 50. Preferably, if the information is manually entered, a form is available that lists the various areas of landlord and tenant responsibilities and the person entering the data enters the responsible party for the specified responsibility item. Preferably, the various items are listed and the person entering the data simply selects the appropriate responsible party from a list of possible responsible parties. In exemplary embodiments, there will be a default responsible party for each item. For example, there may be system defaults based on typical leases. Preferably, the defaults can be updated. For example, there may be specific defaults for a particular building that are different from the defaults of another building. In exemplary embodiments, the responsible party is either the tenant, the landlord, the landlord via tenant impounds, or an association.

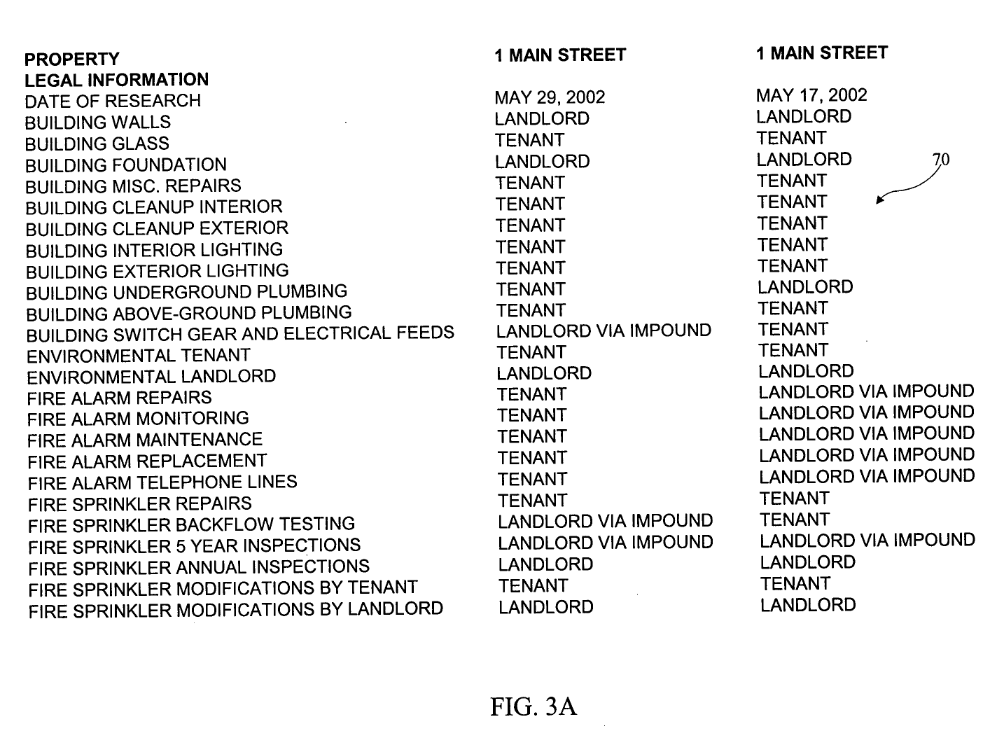

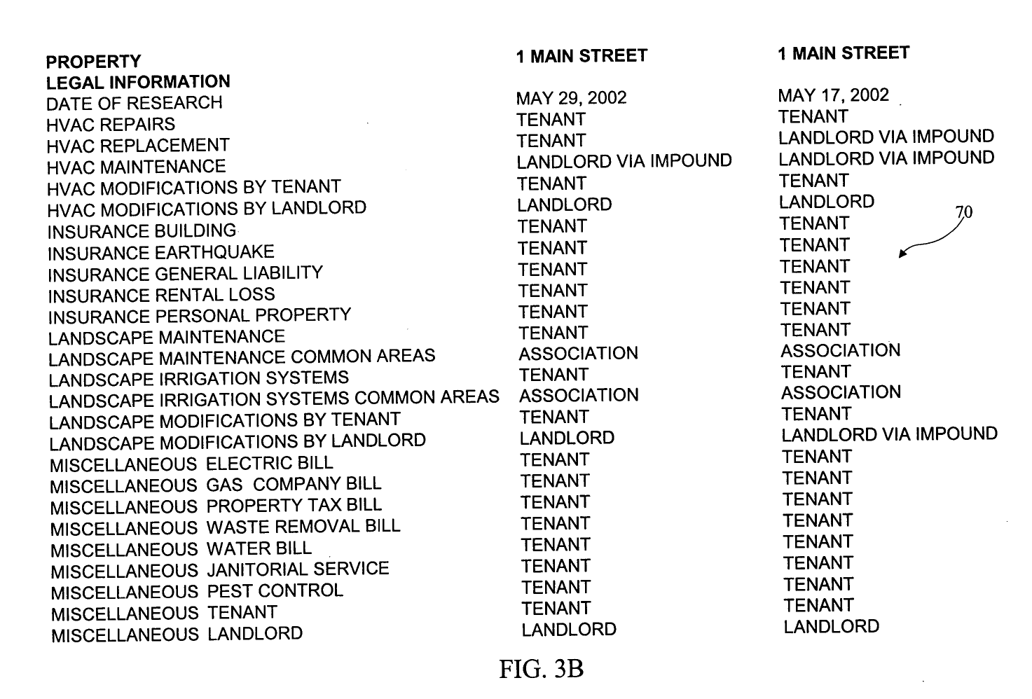

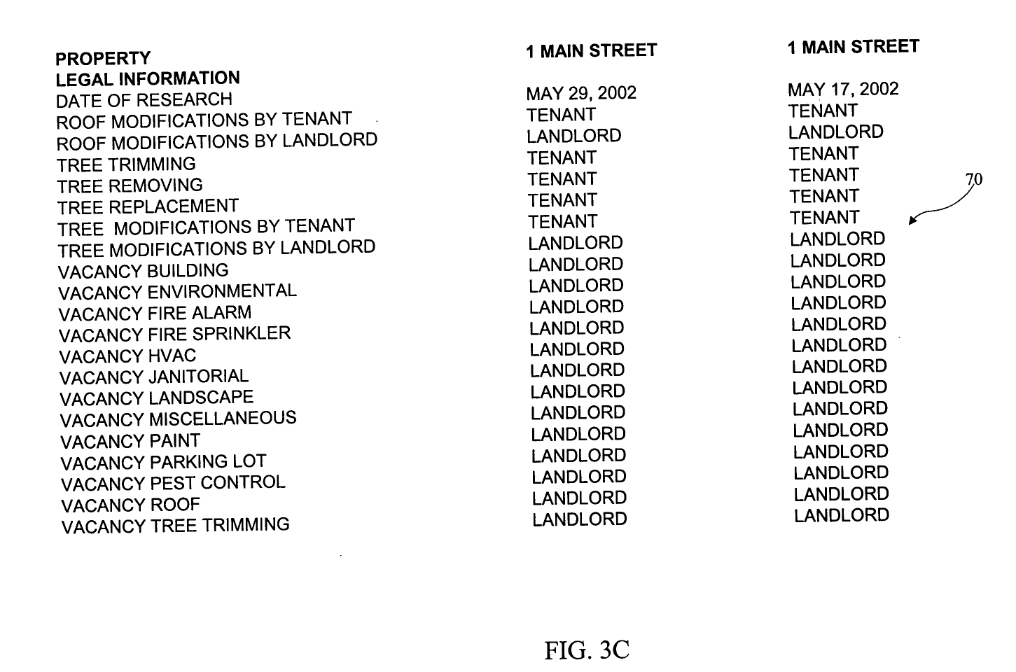

FIG. 3 (FIGS. 3A-3C) illustrates exemplary landlord/tenant responsibility data 70 (lease items and an identification of the party responsible for each of the lease items). In the example shown, there are two properties: one located at “1 Main Street” and one located at “2 Main Street.” For each property, landlord/tenant responsibility information is stored for each of a list of specified items, such as building walls, building glass, building foundation, etc. as shown in FIGS. 3A-3C.

The data may be stored in any manner. For example, the data could be stored in a flat file, using a spreadsheet or in a relational database. For example, if the landlord stores the data on a PC, a database program, such as Microsoft® Access® could be used to store, manage and retrieve the property management data. In exemplary embodiments, in addition to storing the individual data fields pertaining to landlord/tenant responsibilities, an image of the lease is also stored.

A user login (e.g., user name/password) is required for use of the system. The primary users of the system are tenants and landlords. Landlords may further be sub-divided into property owners and property managers. In exemplary embodiments, the tenant can only view information about properties rented/leased by the tenant. In exemplary embodiments, the landlord can insert, change, modify or delete data relating to any of the properties under the control of the landlord. In other embodiments, the owner and property manager may have different levels of access. For example, the owner may be able to insert, change, modify or delete data relating to any of the properties owned by the owner, but the property manager may only be able to view information about all of the properties managed by the property manager (i.e., the property manager may not have the capability to insert, modify or delete data).

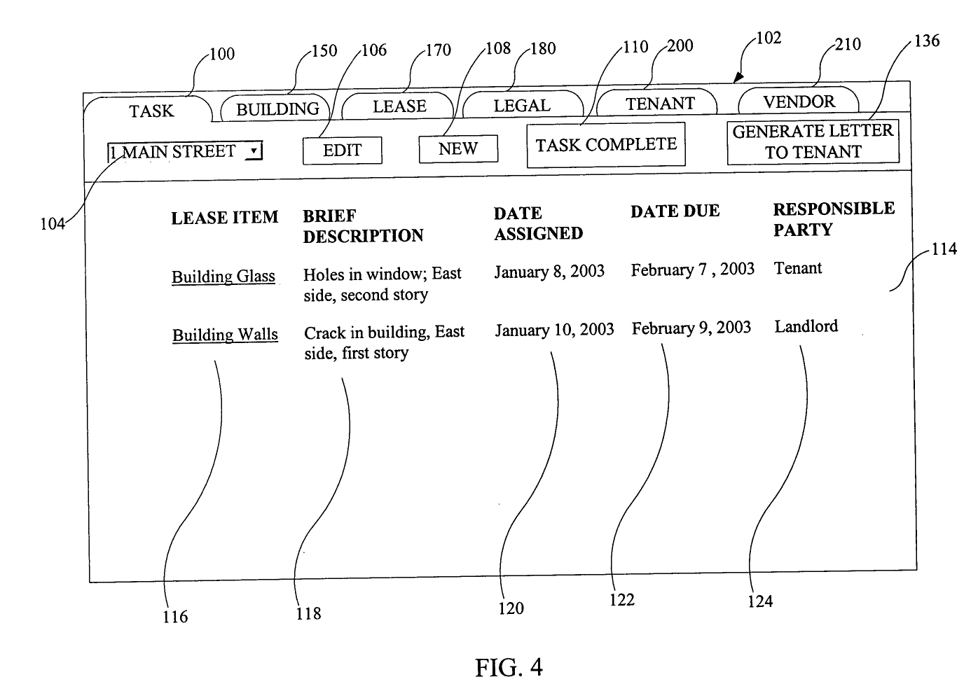

In exemplary embodiments, users access information over a network, such as the Internet. As previously mentioned, the data may be maintained at the landlord's site (FIG. 2A) or there may be a remote site that manages information for multiple landlords (FIG. 2B). Upon verification/validation of the user's name/password, a user interface display provides the user with options available based on the type of user (e.g., landlord/tenant). FIGS. 4-13 illustrate exemplary user interface displays and are described below.

As mentioned above, a login procedure is performed in order to determine the functions available to a specific user. In the exemplary embodiment shown, the user interface looks the same regardless of the type of user (e.g., landlord, tenant, etc.). However, the information and functions available may vary based on the type of user. For example, a tenant only has access to data related to his/her property/properties. A landlord or property manager has access to data for all of the properties for which the landlord or property manager is responsible. The tenant may only be able to view information or may only be able to edit certain fields, such as the tenant's telephone number or e-mail address. The landlord or property manager may be able to add, delete or edit information relating to the properties for which the landlord or property manager is responsible.

FIG. 4 illustrates an exemplary task user interface display 102 for the property management system described herein. The user interface displays shown in FIGS. 4-12 allow the user to perform various functions. In the exemplary embodiment shown, tabs are used to access the various functions. The embodiment shown includes the following tabs: a task tab 100, a building tab 150, a lease tab 170, a legal tab 180, a tenant tab 200 and a vendor tab 210. It will be appreciated that alternative embodiments may use controls other than tabs, such as menus, buttons and/or hyperlinks to perform various functions.

In the example shown in FIG. 4, the task tab 100 has been selected. The task user interface display 102 includes a data area 114 which displays information related to “tasks.” The tasks define items, such as repairs and or maintenance that need to be addressed. In the example shown in FIG. 4, a property identification is selected from a property identification selection list 104. In the embodiment shown, the identification is based on property address. It will be appreciated that in some embodiments, there may be multiple tenants associated with a single property. In such cases, the identification may include the building (property address) and a tenant identification. The tasks associated with the selected property are then displayed in the data area 114 of the task user interface display 102. The information stored and displayed for each task includes a description of the task 118 and the responsible party 124. In the example shown, the task information also includes the date the task was assigned 120 and the task due date 122 for each task. Each task also includes an associated lease item or category 116. The lease item identifies the category of the task as shown in the exemplary list of landlord/tenant responsibilities shown in FIGS. 3A-3C. Each category has an associated responsible party 124.

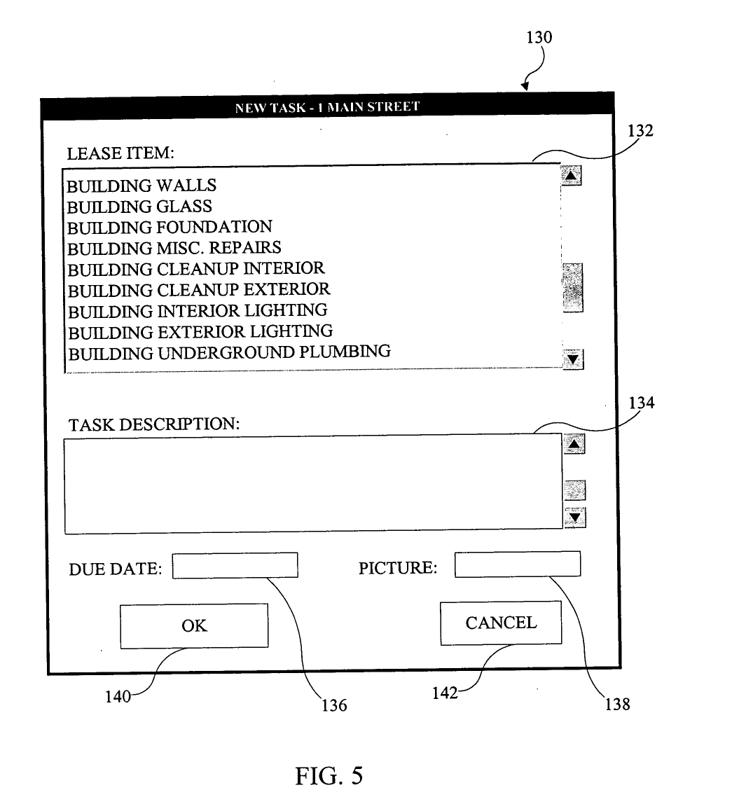

The embodiment shown in FIG. 4 also includes an edit button 106 and a new button 108. If the user selects the new button 108, a new task display user interface 130 such as the one shown in FIG. 5 is displayed. The new task user interface 130 includes a lease item selection list 132 which lists the various lease item categories. An exemplary list of categories is shown in FIGS. 3A-3C. A description of the task can be entered in a task description area 134. A due date can be entered in a due date area 136. In exemplary embodiments, the only information required to create a task is the selection of a lease item from the lease item list 132. In exemplary embodiments, any user (e.g., tenant, landlord/property manager or inspector) can create a new task. In exemplary embodiments, the date that the task is created will automatically be assigned as the task creation date. In exemplary embodiments, any user can enter the task due date. In alternative embodiments, only the landlord/property manager is allowed to enter the due date. In various embodiments, a default due date may be assigned. The default due date may be a standard default, such as thirty days from the task creation date or each lease item may have its own default due date (delta from the task creation date) assigned to it. If the user decides not to create the new task, the user can press a cancel button 142. If the user wants to create the task, the user can press an OK button 140. Selection of the OK button 140 will cause a task create message to be generated. This message is sent to the computer (e.g., server) that includes the software for creating, storing and managing task information for the property management system. The task information in the create task display window 130 is stored, the responsible party is determined, and the appropriate party or parties are notified of the new task.

When a create new task message is received, the responsible party is determined. The selected lease item category is used to retrieve the appropriate responsible party based on the stored lease information for the selected property/tenant. The landlord can view the information by selecting the task tab 100 and the desired property 104 as shown in FIG. 4. The landlord can select an edit button 106 to edit a selected task entry. Selection of the edit task button 106 causes a task edit window to be displayed. In exemplary embodiments the task edit display is the same as the new task display, such as the one shown in FIG. 5. If the lease item selected is not the appropriate lease item based on the entered task description, the landlord can select a different, more appropriate, lease item from the list of lease items 132. The landlord can also change the due date or enter the due date if no due date has yet been assigned to the selected task. After editing the task information as desired, the user presses OK button 140. As with the creation of a new task, an edit task message is sent, the responsible party is determined, and appropriate party or parties are notified. In exemplary embodiments, a new task is assigned a unique identifier. This identifier is used for all tracking (e.g., editing) of the task.

If the landlord creates or edits the task and the responsible party is the tenant, an e-mail message is sent to the tenant notifying the tenant of the task. The e-mail may include the task information (e.g., description, due date, etc). In alternative embodiments, the e-mail simply notifies the tenant that the tenant has one or more pending tasks assigned to him/her. The e-mail includes instructions and/or a link for the tenant to obtain more details about the task(s) assigned to the tenant.

In exemplary embodiments, an inspector performs an inspection of a property. The inspection may uncover deficiencies in the property, such as items that require further inspection, maintenance or repair. The inspector can log on to the property management system and create tasks based on the inspection of the property. In exemplary embodiments, the inspector creates a task for each deficiency item. In exemplary embodiments, the inspector can associate a picture with a task. For example, the user interface shown in FIG. 5 includes a picture file identification field 138 where the inspector can enter a file name for a file (such as a JPEG file) that includes a picture related to the task item. In exemplary embodiments, the file will be stored in a pre-defined location (directory path). In other embodiments, the inspector specifies the path where the picture file is stored. The data area 114 of the task display window 102 or the task information window 130 may also include a mechanism for viewing the picture associated with the task if there is a picture associated with the task. For example, a control, such as a button or an icon (such as a camera) may be displayed in either data area of the task list display window 114 shown in FIG. 4 or the task information window 130 shown in FIG. 5. The user can select the control in order to display the picture, if there is one, associated with a selected task.

In exemplary embodiments, if a user creates a task, the task notification is not sent to the appropriate party/parties until the user has terminated the session. This prevents a user from receiving excessive task notification messages. In exemplary embodiments, if task(s) are assigned to the landlord, the landlord is the only person that receives a message and if tasks are assigned to someone other than the landlord (e.g., task assigned to tenant or to vendor), a message (e.g., e-mail) is sent to the party to whom the task is assigned and a copy (cc) of the message is sent to the landlord. A For example, if an inspector found fourteen deficiencies, eight of which are the tenant's responsibility and six of which are the landlord's responsibility, immediately sending a message after each task is created would cause the tenant to receive eight messages and the landlord to receive fourteen messages. Waiting until the inspector terminates the session causes the tenant to receive one message (notifying the tenant that the tenant has new tasks) and the landlord to receive two messages (one notifying the landlord that the landlord has new tasks and one messages notifying the landlord that the tenant has new tasks).

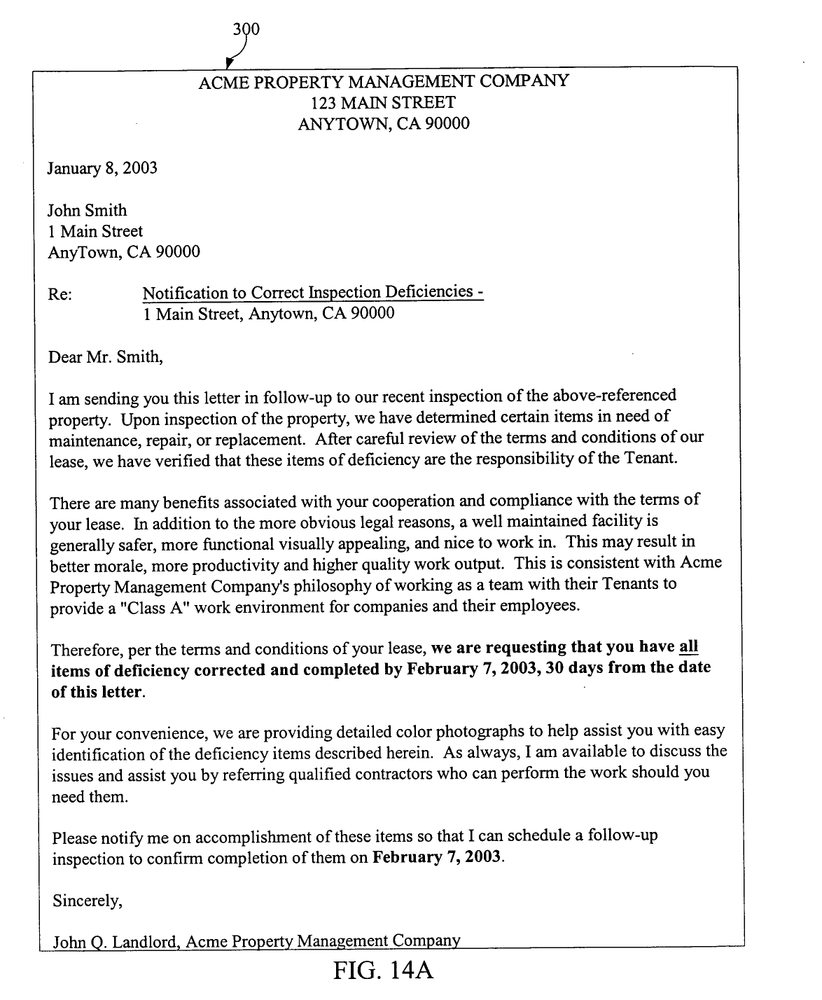

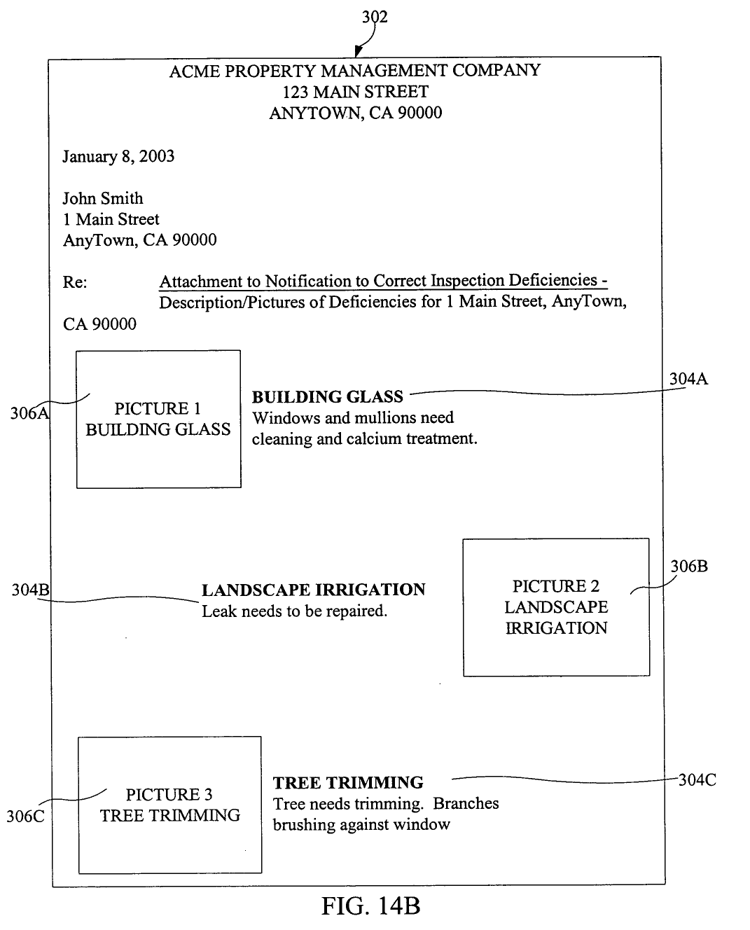

In exemplary embodiments, if the user is a landlord, the task user interface display 102 will also include a button 112 that allows the landlord to generate a letter to the tenant. In one embodiment, the landlord can select one task, multiple tasks or all tasks associated with a property/tenant. The landlord can then generate a letter based on the selected task(s). The landlord can also select whether or not to include pictures, if any, in the letter as shown in FIG. 14B. FIG. 14A illustrates an exemplary letter to the tenant.

FIG. 14A illustrates an exemplary letter to the tenant 300 generated when the Generate Letter to Tenant button 112 is pressed. In exemplary embodiments, the letter is generated in a word processing format such as Microsoft® Word®. The landlord can modify the letter, if desired, or simply sign and mail the letter. In the embodiment shown, an attachment to the letter 302 such as the one shown in FIG. 14B may also generated. The attachment 302 includes text 304A, 304B, 304C, if any, and/or pictures 306A, 306B, 306C, if any, associated with task item(s) pending for the tenant. Sending a letter to the tenant that includes inspection information, particularly photographs, tends to get the tenant's attention and increases the likelihood that the tenant will promptly respond to the maintenance/repair requests.

In exemplary embodiments, if the task is created by someone other than the landlord, and the category selected is a category that is the landlord's responsibility, a verify task responsibility message is sent to the landlord. The landlord can then view the task and verify that the correct category was selected. If the correct category was not selected, the landlord can edit the task and select the appropriate category. If, for example, the category was incorrectly selected and the responsible party for the task should have been the tenant, the task is modified and the tenant is notified of the task assignment to the tenant.

In various embodiments, a lease item may have a vendor associated with the task item. When a task that is the landlord's responsibility is created, a task for the vendor may automatically be created and assigned to the vendor. For example, if roof repairs are the landlord's responsibility and the tenant creates a task requiring roof repairs, the task will automatically be assigned to the landlord. If there is a vendor associated with roof repairs, an embodiment of the system automatically sends an e-mail message to the appropriate vendor notifying the vendor that roof repairs are required.

Some tasks are recurring tasks. For example, fire sprinklers may need to be inspected on an annual basis. For such recurring tasks, the task creator (typically the landlord or property manager) creates the recurring tasks. For example, the landlord may create the recurring tasks at the time that the lease information is entered into the system. The recurring tasks will display the next required task due date. When the current task is complete, the task will be updated to the next recurring date.

The system logs all activity. Therefore, if a task has been marked as complete and does not show up as a pending task, the landlord can still view the history pertaining to the task.

In exemplary embodiments if the user is the landlord, the user interface also includes a task complete button (not shown) that allows the landlord to change the status of a task to “complete.” In the case of a recurring task, the task remains, but the task due date changes to the next due date.

In exemplary embodiments, the tasks shown in the task data window 114 can be sorted, for example by responsible party or by due date. Furthermore, in exemplary embodiments, the responsible party and landlord can be notified of an approaching due date or a past due date. In exemplary embodiments, if a task is not marked as “complete” prior to its due date, the responsible party and landlord are notified. In one embodiment, the landlord receives a notification, e.g., an e-mail. In one embodiment, the landlord can view the tasks sorted by due date. The landlord can select one task, multiple tasks or all tasks. The landlord can mark the selected task(s) as complete or change the due date of the selected tasks(s).

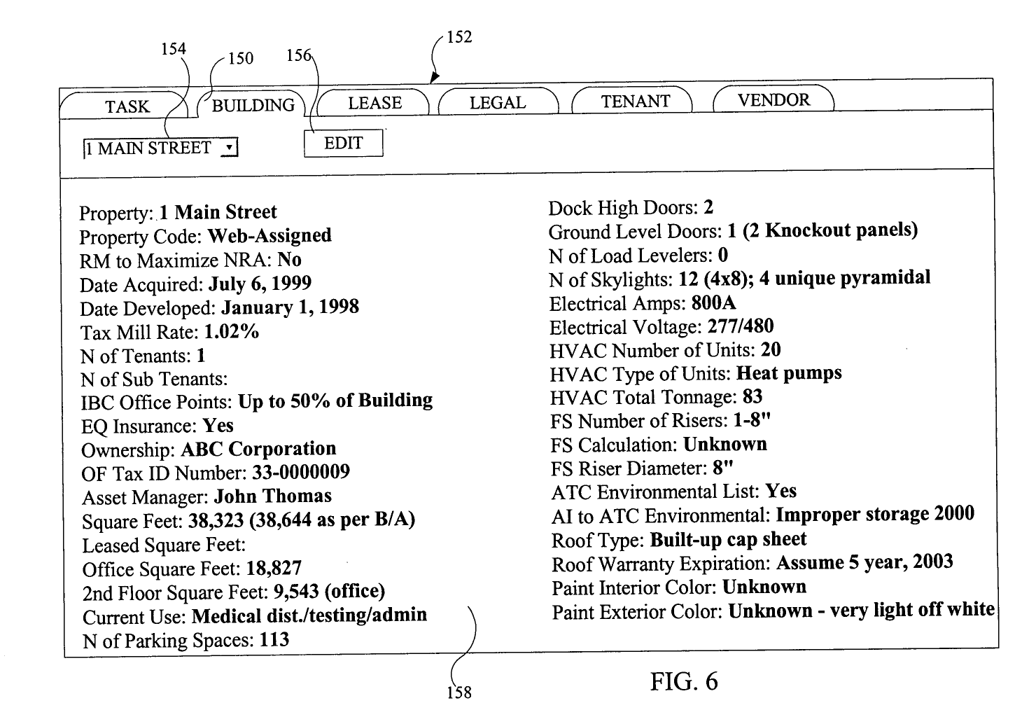

FIG. 6 displays a building user interface display 152 that is displayed when the user has selected the building tab 150. The data area 158 displays stored information about the selected property 154. The building user interface display 152 includes an edit button 156. Selection of the edit button 156 allows the user to modify data about the building displayed in the data area 158. In exemplary embodiments, only the landlord or property manager can edit the building data.

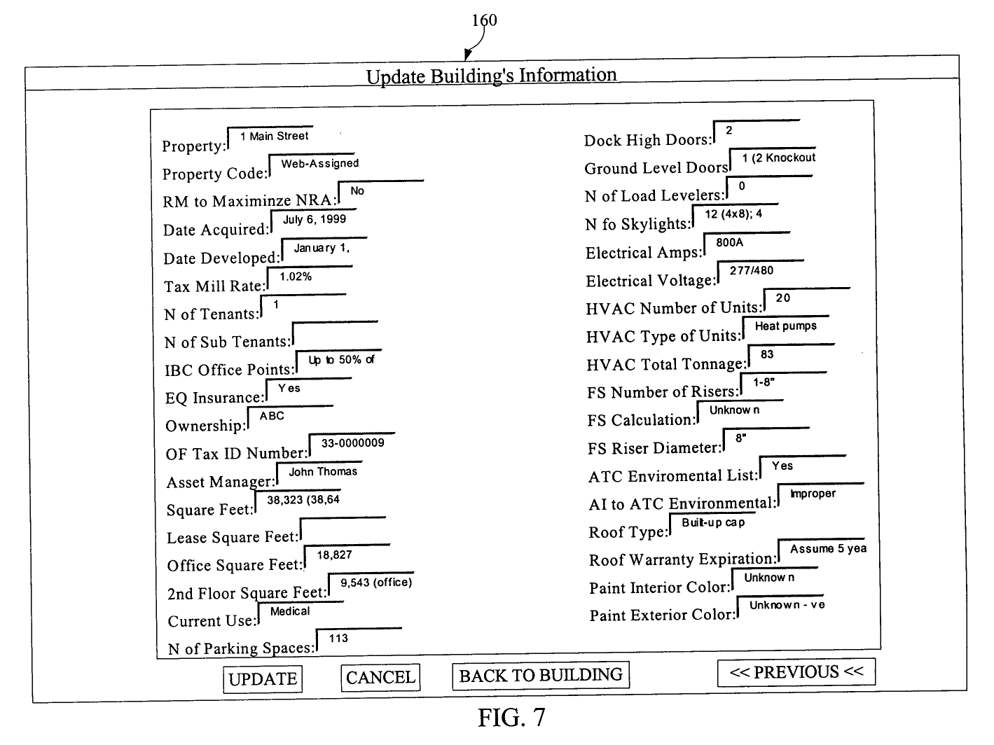

FIG. 7 is an exemplary edit building user interface display 160. It is similar to the display building window shown in FIG. 6, but includes edit boxes that allow the user (e.g., landlord or property manager) to edit the building data.

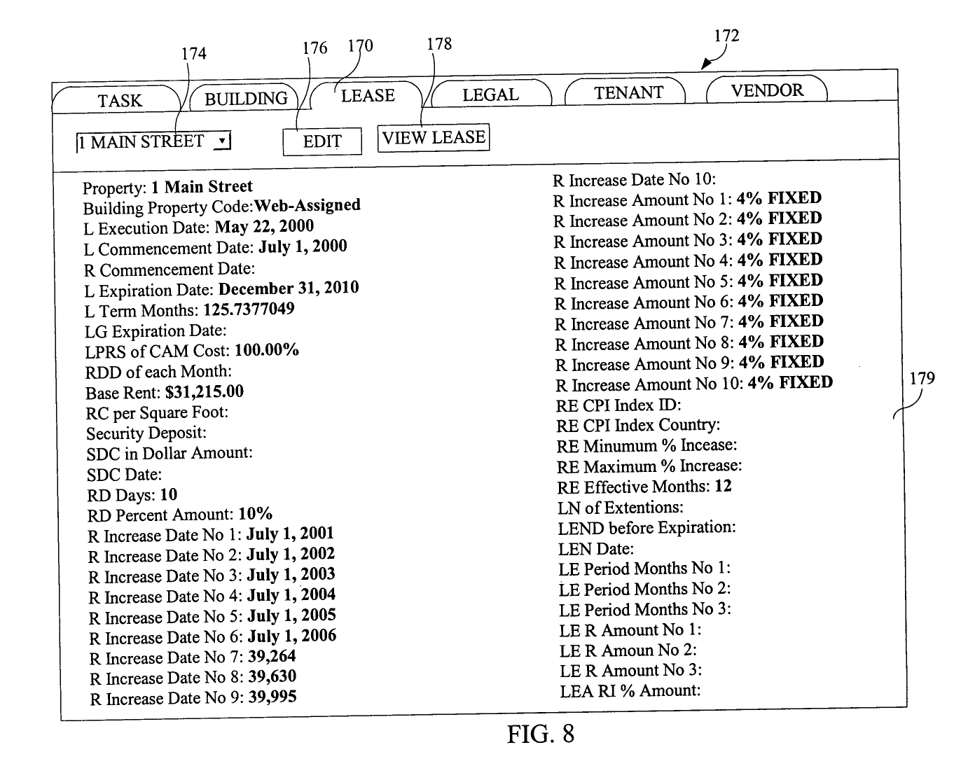

FIG. 8 illustrates an exemplary lease user interface display 172 that is displayed when the user has selected the lease tab 170. The data area 179 displays stored information about the lease for the selected property 174. The lease user interface display 172 includes an edit button 176. Selection of the edit button 176 allows the user to modify data about the building displayed in the data area 179. In exemplary embodiments, only the landlord or property manager can edit the building data. In exemplary embodiments, the user can also view a copy of the lease by pressing a View Lease button 178.

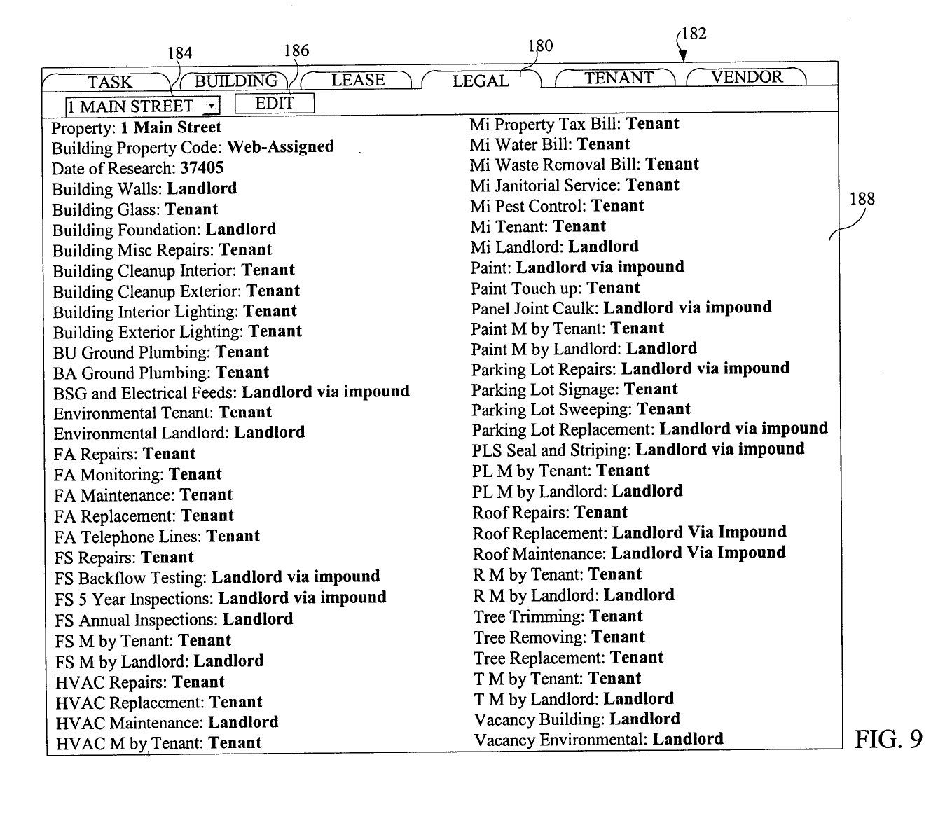

FIG. 9 is an exemplary embodiment of a legal user interface 182 that is displayed when a user selects the legal tab 180. The legal user interface displays the legal (responsibility) information for a selected property/tenant 184. The data area 188 displays the responsibility information from the tenant's lease. The legal user interface 182 includes an edit button 186 that allows the landlord to edit the legal (responsibility) information. If, for example, the category information was erroneously entered or the lease were amended, the landlord could edit the legal (responsibility) information so that the appropriate responsible party is associated with the lease item.

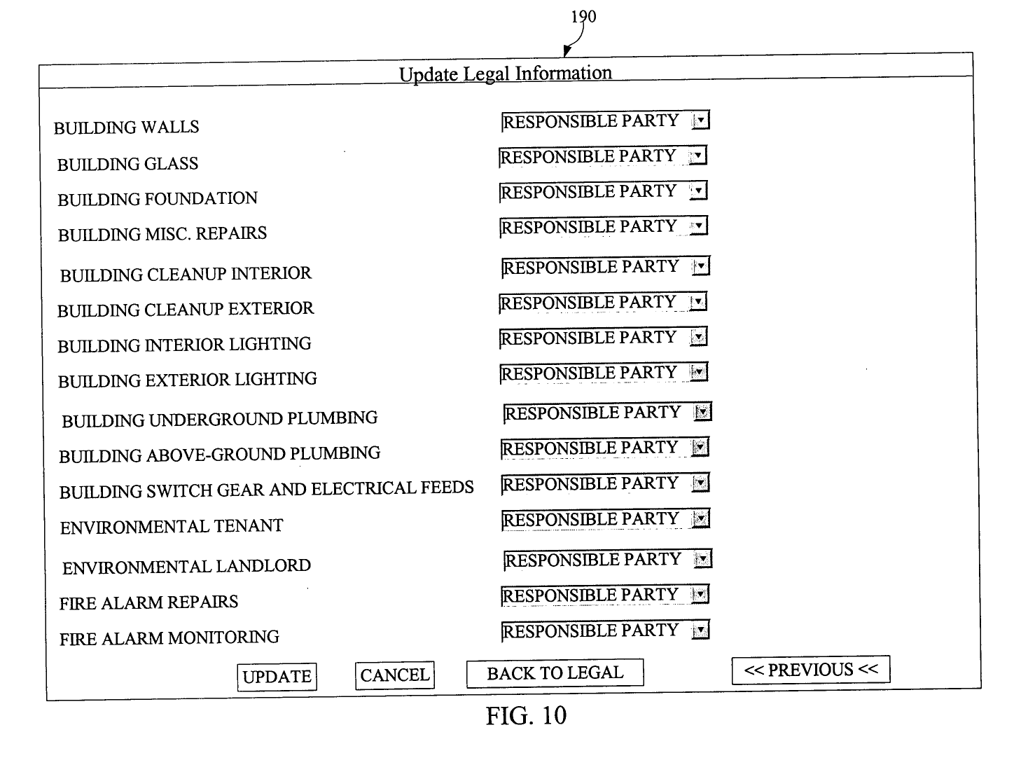

If the landlord selects the edit button 186, an edit legal information user interface display 190 such as the one shown in FIG. 10 is displayed and allows the landlord to change the legal (responsibility) information for the selected property tenant 184. In exemplary embodiments, the edit legal information display is the same as the user interface used to initially store the legal (responsibility) information. In exemplary embodiments, the user interface display for entering (or editing) the legal information includes all of the lease items and a selection box that allows the person entering information to select the responsible party (e.g., landlord, tenant, landlord via impound or association) for each lease item.

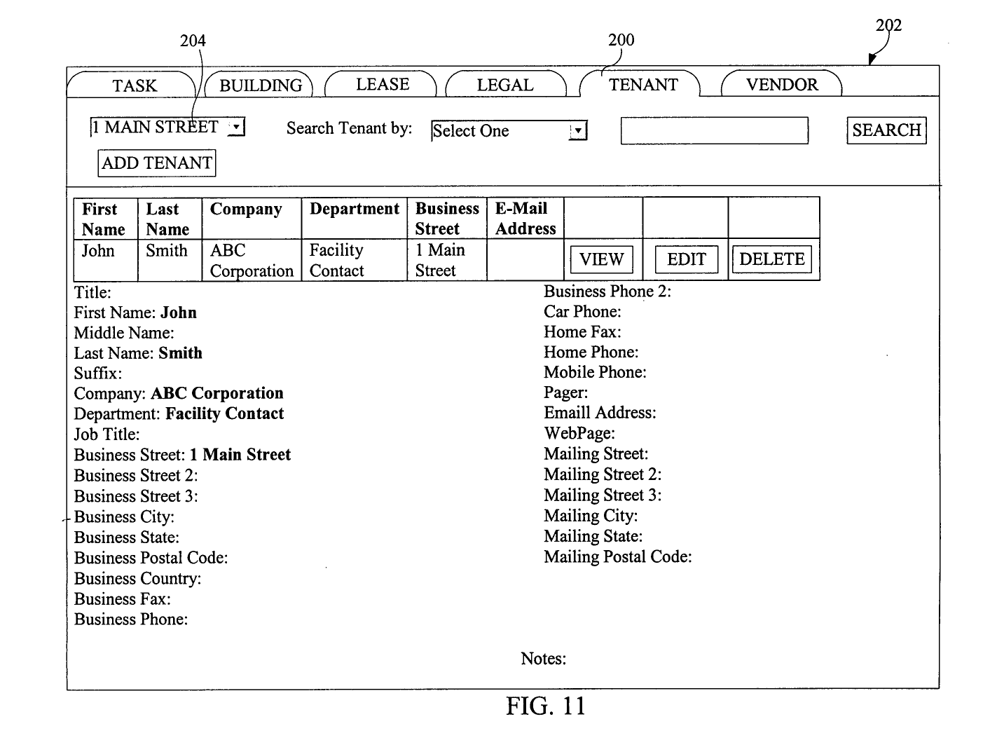

FIG. 11 is an exemplary tenant user interface display 202 that is displayed when a user selects the tenant tab 200. The tenant user interface display 202 includes a data area 206 that displays information about the tenant, such as identification and contact information for the tenant.

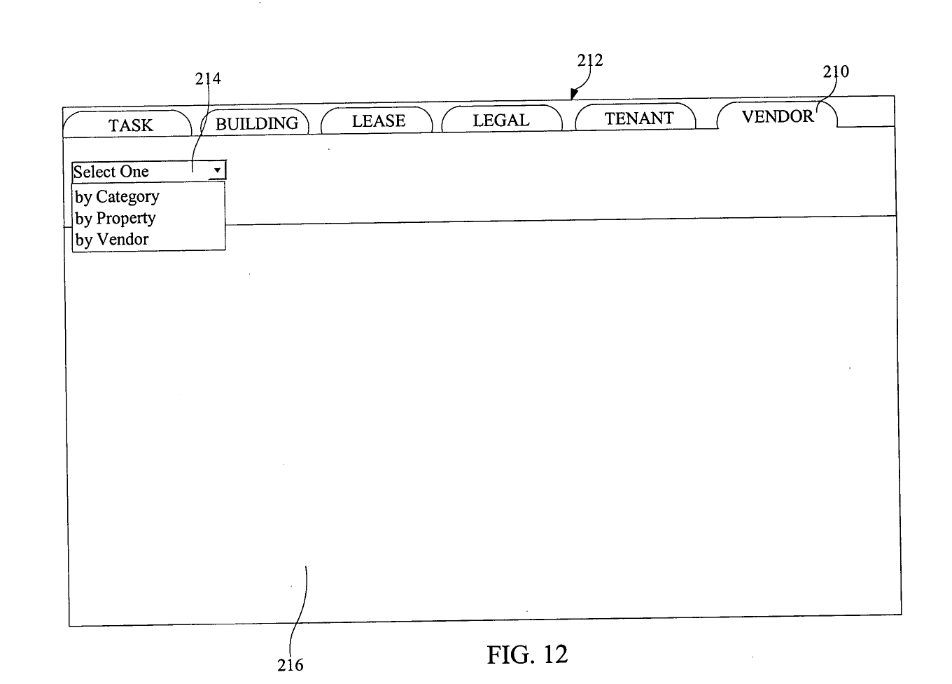

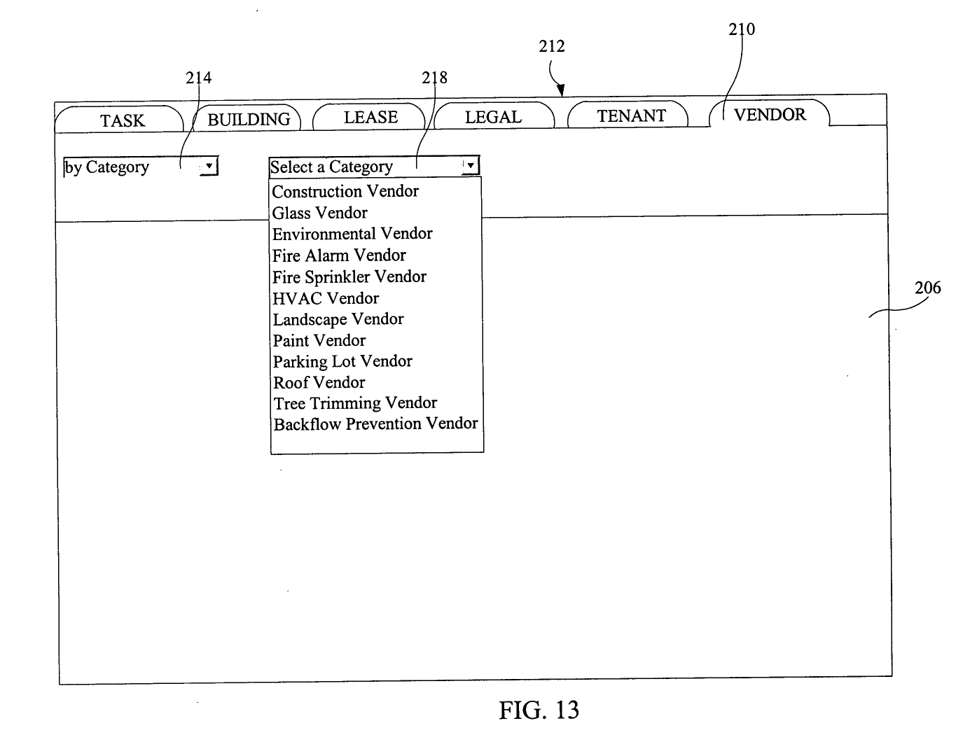

In exemplary embodiments, vendor information is stored. The vendor information includes the type of vendor as well as which properties are to be serviced by the vendor. FIG. 12 illustrates an exemplary vendor user interface display 212 that is displayed when the vendor tab 210 is selected. The vendor user interface display 212 includes a selection list 214 that allows the user to select how the vendor information will be displayed. In the embodiment shown, the information may be displayed by category, by property or by vendor. If for example, the user opts to display vendor information by category, a category list is displayed as shown in FIG. 13. The user then selects a category from a category list 218. The stored vendor information is searched and the appropriate information for the vendor(s), if any, for the selected category is displayed in the data area 216.

In exemplary embodiments, there may be multiple vendors that are used to perform the same function(s). These multiple vendors may at times work on the same property/properties. In such cases, when a repair or maintenance is required and the landlord/property management is responsible for the repair or maintenance, a notification may go out to multiple vendors requesting a bid/estimate for the particular task.

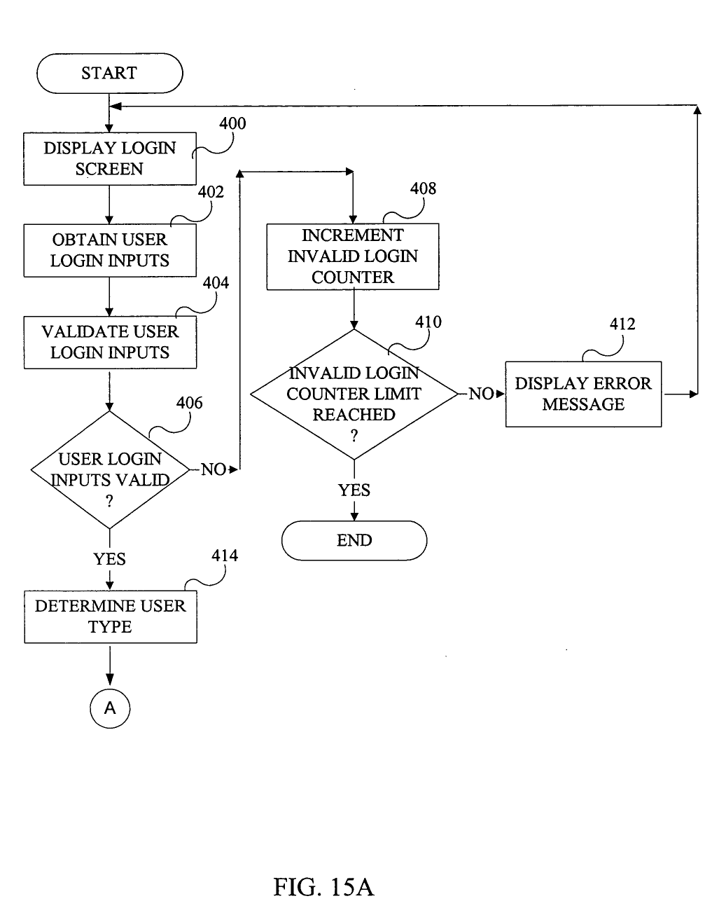

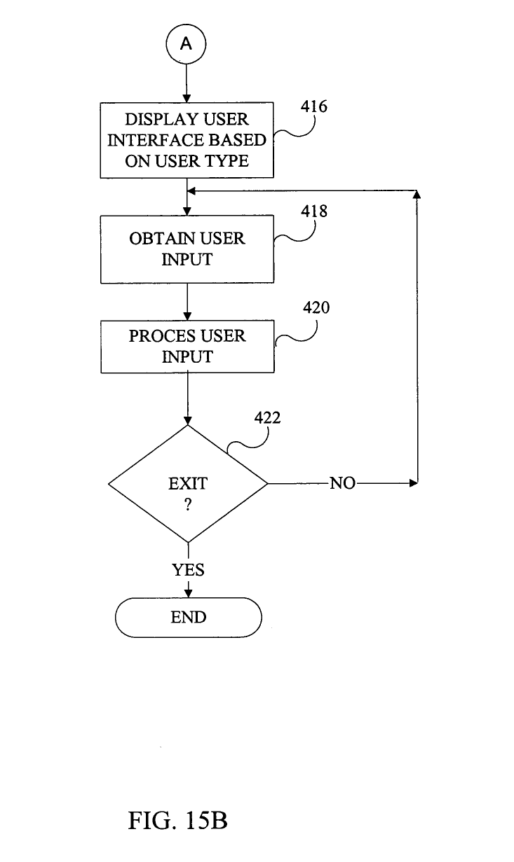

FIGS. 15A-15B are a flow diagram illustrating exemplary logic for a property management system for facilitating the determination landlord/tenant responsibilities as described herein. The logic of the exemplary flow diagram shown in FIGS. 15A-15B is for a system that includes landlords, tenants and inspectors as users who can perform functions as shown in the exemplary user interfaces shown in the figures and described above.

The logic of FIG. 15A moves from a start block to block 400 where a login screen is displayed. As mentioned above, in exemplary embodiments users can access the system via the Internet. In such cases, the user will use a browser to go the home page of the property management system server. The home page may display the user login screen or may include a link that allows the user to display a page having the user login screen. The user login screen includes prompts or form fields that allow the user to enter an identification (e.g., name) and a password.

After the user enters the login information, the information entered by the user is transmitted to the server. See block 402. The logic then moves to block 404 where the information obtained from the user is validated.

If the information entered by the user is not valid (no in decision block 406), the logic moves to block 408 where an invalid login counter is incremented. In exemplary embodiments, if the user does not enter a valid username/password combination within a predetermined number of attempts (e.g., three attempts), the user is blocked for a certain period of time from further login attempts. If the user has exhausted the available number of login attempts (yes in decision block 410, the logic of FIG. 15 ends. If the number of failed login attempts is less than the predetermined limit (no in decision block 410), the logic moves to block 412 where an error message is displayed. The logic then returns to block 400 where the login screen is displayed so that the user can again try to login. The logic of blocks 400-412 is repeated until the user has reached the allowable limit of login attempts (yes in decision block 410) or the user enters valid login information (yes in decision block 406).

If valid login information is obtained from the user (yes in decision block 406), the logic moves to block 414 to determine the user type. In exemplary embodiments, user types include landlord, tenant and inspector. The user type determines the available functions for the user. As described above, some functions, such as generating a letter to the tenant designating tasks as complete, editing lease information, etc. may only be performed by the landlord/property manager.

The logic proceeds to block 416 (FIG. 14B) where the user interface is displayed. The user interface is based on the user type as determined in block 414. For example, the landlord/property manager user interface may have controls (e.g., buttons) that are not displayed on user interfaces for other user types, such as tenants and inspectors.

The logic then moves to block 418 where user input is obtained. For example, the user may select a tab, press a button, select a menu item, or enter information in an edit box. The logic then moves to block 420 where the user input obtained in block 418 is processed. The logic of block 418 through 420 is repeated until it is time to exit (yes in decision block 422).

The exemplary embodiment shown and described herein is concerned with the property management function of determining who is responsible for a matter, such as a repair, maintenance or billing item and notifying the appropriate party or parties of who is responsible for the matter. It will be appreciated that such a system may only perform functions associated with determination and notification of responsibilities. However, it will also be appreciated that the system may include other property management functions or the functionality described herein may be incorporated into a system that performs other property management functions.

Exemplary embodiments include a Data Import/Export feature that allows users to Import/Export detailed system information that can be filtered, exported and used in other popular software programs. For example, contact information for both tenants and vendors can be imported and exported to and from Microsoft Outlook®, Microsoft Excel™, and other off-the-shelf contact management software packages. Exemplary embodiments configure internal data tables so that data can be imported/exported from/to various off-the-shelf programs.

Exemplary embodiments include an accounting system link feature that links with and displays data from the landlord's existing accounting system, such as QuickBooks®, allowing the landlord to review recurring expenses and capital expenditures by property and provide detailed reports used in the creation of annual budgets for each property. This feature used with the data import/export feature allows the importing of specific accounting transactions into the system data tables required to reconcile landlord impound account balances, funds used to date, and funds available for future needed repairs and improvements for any specific tenant. These past history expense transactions may also be used in the review of past activity/history on any new building deficiency or recurring problem associated with a property or tenant.

Additional modifications and improvements of the present invention may also be apparent to those of ordinary skill in the art. Thus, the particular combination of parts described and illustrated herein is intended to represent only a certain embodiment of the present invention, and is not intended to serve as a limitation of alternative devices within the spirit and scope of the invention.

1. A method of managing a plurality of real estate properties, the method comprising:
a. providing storage for and access to tenant/property information relating to the plurality of real estate properties, the tenant/property information for each real estate property comprising an identification of a responsible party for each of a plurality of lease items;
b. in response to a query as to identification of a responsible party for a respective lease item for a respective real estate property, retrieving the identification of the responsible party for the respective lease item for the respective real estate property; and
c. providing the identification of the responsible party for the respective lease item for the respective real estate property.

2. The method of claim 1, wherein the identification of the responsible party for each of the plurality of specified lease items is selected from the group consisting of:
landlord;
tenant;
landlord via impound; and
association.

3. The method of claim 1, further comprising before b:
providing a user interface for entry of user identification information;
obtaining user identification information from a user;
validating the user identification information; and
if the user identification information is valid, determining a user type based on the user identification information.

4. The method of claim 3, further comprising:
providing a user interface for a user to create a task associated with the respective real estate property;
accepting information relating to the task, the information relating to the task including an identification of a respective lease item; and
determining the responsible party for the task based on the respective lease item.

5. The method of claim 4, further comprising notifying the responsible party about the task.

6. The method of claim 5, further comprising, if the responsible party is not a landlord, notifying the landlord of the task.

7. The method of claim 4, wherein the user interface displays task information associated with the respective real estate property, the task information including a task entry for each task associated with the respective real estate property, each task entry including the identification of the respective party for the respective lease item.

8. The method of claim 4, wherein a picture is associated with the task.

9. The method of claim 4, wherein if the user type is landlord, the user can generate a deficiency letter containing information about tasks associated with the respective property that are assigned to a tenant.

10. The method of claim 4, wherein if the user type is landlord, the user can edit information about the tasks associated with the respective property.

11. The method of claim 4, wherein if the user type is landlord, the user can designate a task associated with the respective property as complete.

12. The method of claim 4, wherein if the user type is landlord, the user can create recurring tasks associated with the respective property.

13. The method of claim 1, further comprising displaying a user interface that displays a copy of a lease associated with the respective real estate property.

14. The method of claim 1, further comprising displaying a user interface that displays building information associated with a respective real estate property.

15. The method of claim 1, further comprising displaying a user interface that displays tenant information associated with a respective real estate property.

16. The method of claim 1, further comprising displaying a user interface that displays vendor information associated with a respective real estate property.

17. The method of claim 1, further comprising importing data from an external program.

18. The method of claim 1, further comprising exporting data to an external program.

19. A system for managing a plurality of real estate properties, the system comprising:
a landlord tenant responsibility data repository configured to store data about a plurality of real estate properties, the data repository comprising an identification of a responsible party for each of a plurality of specified lease items for each of the real estate properties;
at least one landlord computer configured to store the identification of the responsible party for each of the plurality of specified lease items for each of the real estate properties in the data repository and to access the stored identification of the responsible party for each of the plurality of specified lease items for each of the real estate properties from the data repository;
at least one tenant computer configured to access the stored identification of the responsible party for each of the plurality of specified lease items for at least a respective one of the real estate properties; and
a communication medium for facilitating the access of the stored identification of the responsible party for each of the plurality of specified lease items for at least a respective one of the real estate properties by the at least one tenant.

20. The system of claim 19, wherein the least one tenant computer accesses the stored identification of the responsible party for each of the plurality of specified lease items for at least a respective one of the real estate properties over the Internet.

21. The system of claim 19, further comprising at least one inspector computer configured to store inspection information for at least one of the real estate properties.

22. The method of claim 19, further comprising a server, and wherein there are multiple landlord computers.
